(19) United States
(12) Patent Application Publication
(10) Pub. No.: US 2002/0171924 A1
(43) Pub. Date: Nov. 21, 2002

(54) Telescope viewing system

(76) Inventors: Jerry W. Varner, Cowen, WV (US); Gelida C. Varner, Cowen, WV (US)

Correspondence Address: Michael S. Neustel, Suite No. 4, 2534 South University Drive, Fargo, ND, 58103, US

(21) Appl. No.: 09/858,229

(22) Filed: May 15, 2001

(51) Int. Cl. G02B 21/36; G02B 23/00

(52) U.S. Cl. 359/363; 359/399

(57) ABSTRACT

A telescope viewing system for conveniently viewing celestial objects without being personally subjected to the elements of weather. The telescope viewing system includes a telescope, a lens cover removably surrounding an end portion of the telescope, a camera attachable to an eyepiece of the telescope using a coupler member, and a computer system in communication with the camera for displaying images recorded by the camera upon a display screen.

### BACKGROUND OF THE INVENTION

1. Field of the Invention

The present invention relates generally to telescope devices and more specifically it relates to a telescope viewing system for conveniently viewing celestial objects without being personally subjected to the elements of weather.

2. Description of the Prior Art

Telescopes have been in use for years. A conventional telescopes are comprised of a tubular shape with a plurality of lenses within and at least one eyepiece for viewing celestial objects such as stars and planets. Some telescopes utilize motorized controls for rotating, tilting and zooming the telescope. ORION TELESCOPES & BINOCULARS sells a wide variety of such telescopes that are considered conventional in the art at www.telescope.com.

The main problem with conventional telescopes is that an individual utilizing the telescope must personally be outside with the telescope thereby being undesirably subjected to the weather. A further problem with conventional telescopes is that they do not provide a convenient means for a user to view celestial objects. A further problem with conventional telescopes is that they must be positioned upon a support stand that is accessible by the user, thereby making them prone to visual obstructions such as trees and adjacent buildings.

Examples of patented telescope related devices which are illustrative of such prior art include U.S. Pat. No. 5,133,050 to George et al; U.S. Pat. No. 4,682,091 to Krewalk et al; U.S. Pat. No. 4,764,881 to Gagnon; U.S. Pat. No. 5,579,165 to Michel et al.

While these Internet based systems may be suitable for the particular purpose to which they address, they are not as suitable for conveniently viewing celestial objects without being personally subjected to the elements of weather. Conventional telescopes are not easy to utilize for individuals that do not desire to be subjected to outside weather conditions. In addition, conventional telescopes must be positioned in locations that are both convenient for the user to access and that are not obstructed by exterior objects such as trees and buildings.

In these respects, the telescope viewing system according to the present invention substantially departs from the conventional concepts and designs of the prior art, and in so doing provides a system primarily developed for the purpose of conveniently viewing celestial objects without being personally subjected to the elements of weather.

### SUMMARY OF THE INVENTION

In view of the foregoing disadvantages inherent in the known types of telescopes now present in the prior art, the present invention provides a new telescope viewing system wherein the same can be utilized for conveniently viewing celestial objects without being personally subjected to the elements of weather.

The general purpose of the present invention, which will be described subsequently in greater detail, is to provide a new telescope viewing system that has many of the advantages of the telescopes mentioned heretofore and many novel features that result in a new telescope viewing system which is not anticipated, rendered obvious, suggested, or even implied by any of the prior art telescopes, either alone or in any combination thereof.

To attain this, the present invention generally comprises a telescope, a lens cover removably surrounding an end portion of the telescope, a camera attachable to an eyepiece of the telescope using a coupler member, and a computer system in communication with the camera for displaying images recorded by the camera upon a display screen.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a telescope viewing system that will overcome the shortcomings of the prior art systems.

A second object is to provide a telescope viewing system for conveniently viewing celestial objects without being personally subjected to the elements of weather.

Another object is to provide a telescope viewing system that may be positioned upon various locations of a building such as but not limited to the roof, wall or deck.

An additional object is to provide a telescope viewing system that allows a user to view celestial objects from the interior comfort of their home.

A further object is to provide a telescope viewing system that may be remotely controlled by the user via a computer system.

Another object is to provide a telescope viewing system that may be utilized by individuals of all ages and abilities.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a side view of the present invention.

FIG. 2 is an upper perspective view of the camera attached to the eyepiece of the telescope.

FIG. 3 is a front view of the lens cover attached to the telescope.

FIG. 4 is a side view of the telescope with the camera attached and the lens cover exploded.

FIG. 5 is a block diagram illustrating an exemplary computer system.

FIG. 6 is a block diagram illustrating the connections between the camera and the display with the computer system.

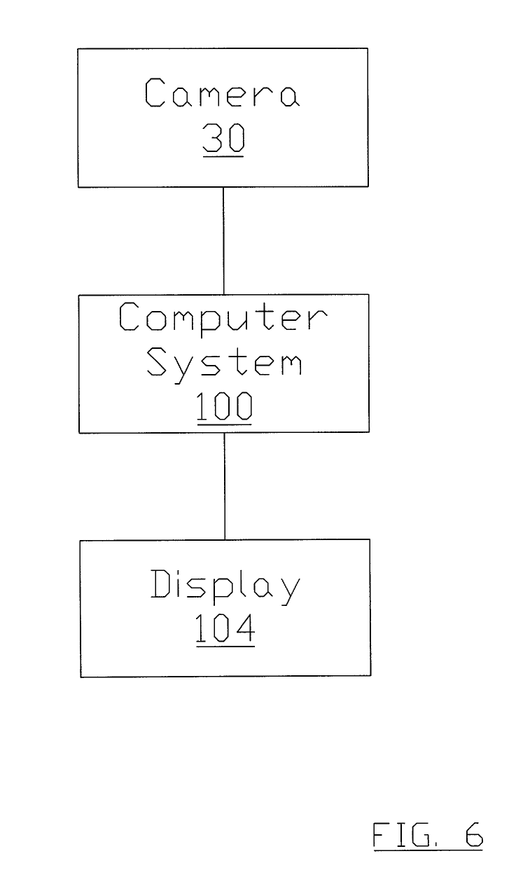

### DESCRIPTION OF THE PREFERRED EMBODIMENT

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital video discs), and computer instruction signals embodied in a transmission medium (with or without a carrier wave upon which the signals are modulated). For example, the transmission medium may include a communications network, such as the Internet.

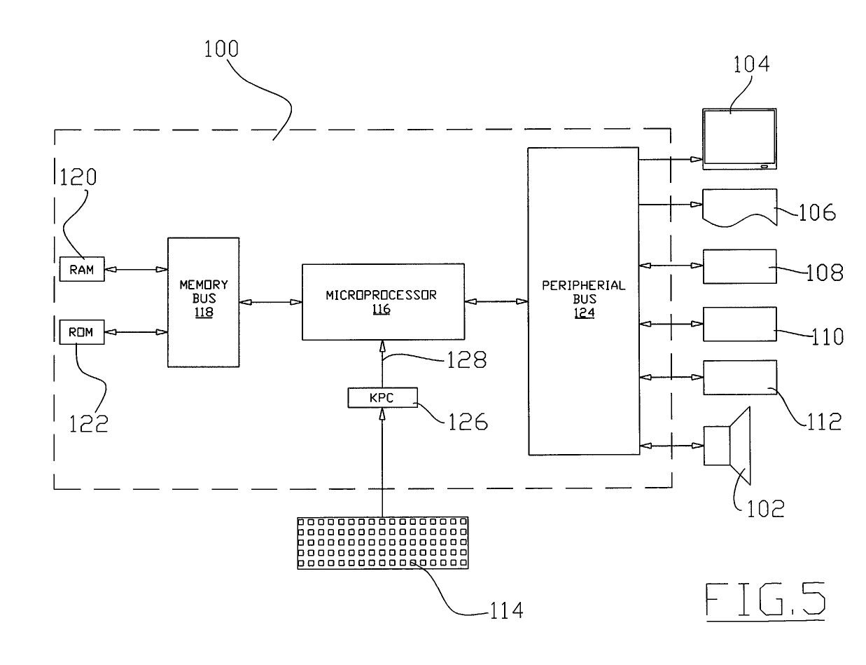

FIG. 5 is a block diagram of an exemplary computer system 100 for practicing the various aspects of the present invention. The computer system 100 includes a display screen (or monitor) 104, a printer 106, a floppy disk drive 108, a hard disk drive 110, a network interface 112, and a keyboard 114. Computer system 100 includes a microprocessor 116, a memory bus 118, random access memory (RAM) 120, read only memory (ROM) 122, a peripheral bus 124, and a keyboard controller 126. Computer system 100 can be a personal computer (such as an APPLE computer, an IBM computer, or one of the compatibles thereof), a workstation computer (such as a SUN MICROSYSTEMS or HEWLETT-PACKARD workstation), or various other types of computers.

The microprocessor 116 is a general-purpose digital processor that controls the operation of the computer system 100. Microprocessor 116 can be a single-chip processor or implemented with multiple components. Using instructions retrieved from memory, microprocessor 116 controls the reception and manipulations of input data and the output and display of data on output devices.

The memory bus 118 is utilized by the microprocessor 116 to access the RAM 120 and the ROM 122. RAM 120 is used by microprocessor 116 as a general storage area and as scratch-pad memory, and can also be used to store input data and processed data. ROM 122 can be used to store instructions or program code followed by microprocessor 116 as well as other data.

Peripheral bus 124 is used to access the input, output and storage devices used by the computer system 100. In the described embodiment(s), these devices include a display screen 104, a printer device 106, a floppy disk drive 108, a hard disk drive 110, and a network interface 112. A keyboard controller 126 is used to receive input from the keyboard 114 and send decoded symbols for each pressed key to microprocessor 116 over bus 128.

The display screen 104 is an output device that displays images of data provided by the microprocessor 116 via the peripheral bus 124 or provided by other components in the computer system 100. The printer device 106 when operating as a printer provides an image on a sheet of paper or a similar surface. Other output devices such as a plotter, typesetter, etc. can be utilized in place of, or in addition to, the printer device 106.

The floppy disk drive 108 and the hard disk drive 110 can be utilized to store various types of data. The floppy disk drive 108 facilitates transporting such data to other computer systems, and the hard disk drive 110 permits fast access to large amounts of stored data.

The microprocessor 116 together with an operating system operate to execute computer code and produce and use data. The computer code and data may reside on RAM 120, ROM 122, or hard disk drive 120. The computer code and data can also reside on a removable program medium and loaded or installed onto computer system 100 when needed. Removable program mediums include, for example, CD-ROM, PC-CARD, floppy disk and magnetic tape.

The network interface circuit 112 is utilized to send and receive data over a network connected to other computer systems. An interface card or similar device and appropriate software implemented by microprocessor 116 can be utilized to connect the computer system 100 to an existing network and transfer data according to standard protocols.

The keyboard 114 is used by a user to input commands and other instructions to the computer system 100. Other types of user input devices can also be used in conjunction with the present invention. Other types of user input devices can also be utilized in conjunction with the present invention. For example, pointing devices such as a computer mouse, a track ball, a stylus, or a tablet to manipulate a pointer on a screen of the computer system 100.

The present invention can also be embodied as computer readable code on a computer readable medium. The computer readable medium is any data storage device that can store data which can be thereafter be read by a computer system. Examples of the computer readable medium include read-only memory, random-access memory, magnetic data storage devices such as diskettes, and optical data storage devices such as CD-ROMs. The computer readable medium can also be distributed over a network coupled computer systems so that the computer readable code is stored and executed in a distributed fashion.

The telescope viewing system 10 is basically comprised of a telescope 20, a lens cover 29 removably surrounding an end portion of the telescope 20, a camera 30 attachable to an eyepiece 28 of the telescope 20 using a coupler member 34, and a computer system 100 in communication with the camera 30 for displaying images recorded by the camera 30 upon a display screen 104.

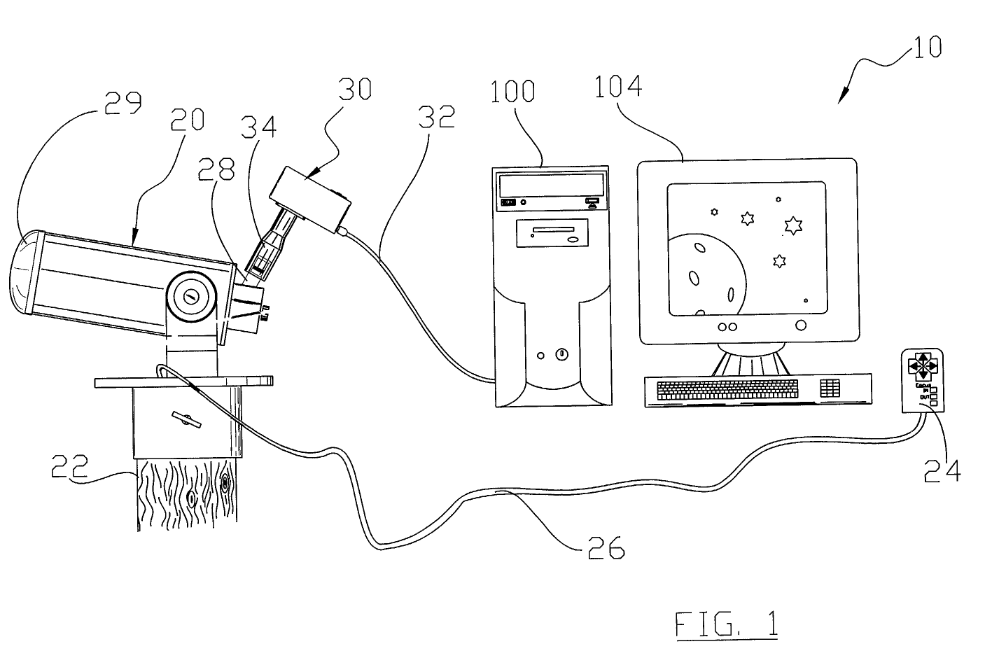

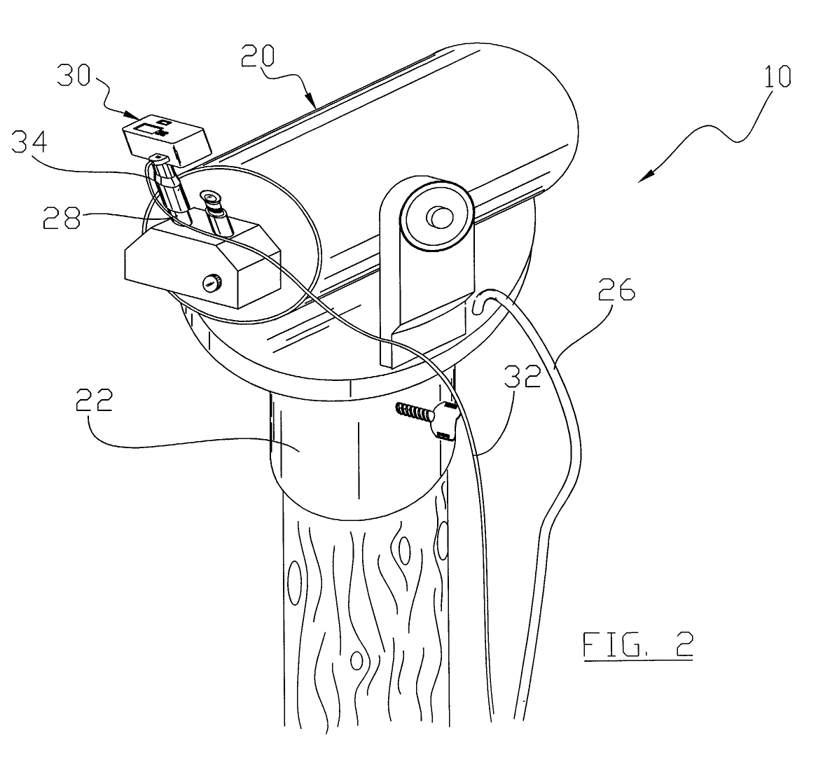

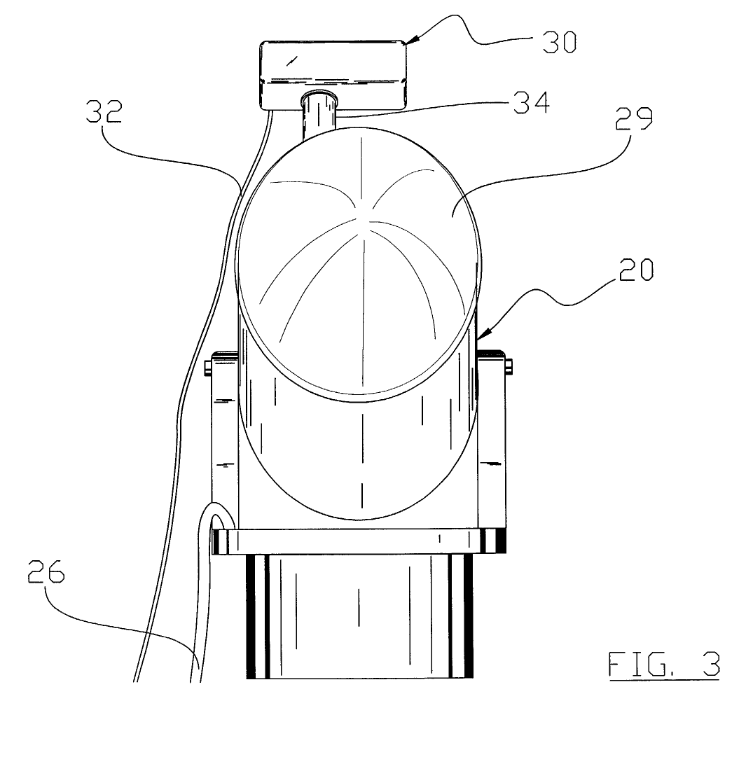

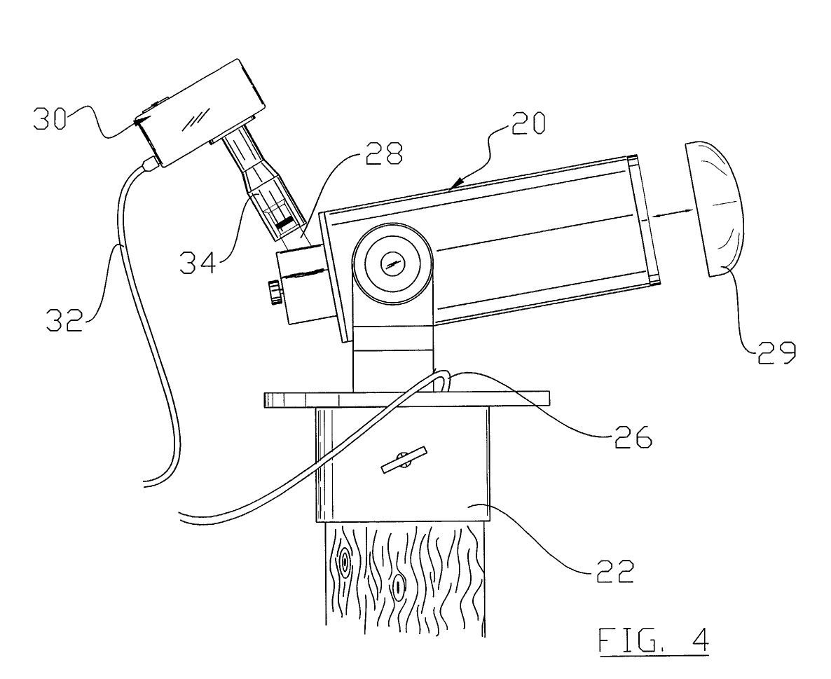

As shown in FIGS. 1 through 4 of the drawings, the telescope 20 has a tubular structure with a distal lens at one end and an eyepiece 28 at the opposite end thereof. The eyepiece 28 is utilized by an individual to directly view celestial objects and has a tubular shape extending upwardly at an angle as best illustrated in FIG. 4 of the drawings. The telescope 20 may be pivoted and rotated about a support structure that are commonly utilized within the telescope 20 industry which may or may not be motorized.

The present invention preferably utilizes a telescope 20 that has a motorized system for allowing remote adjustment of the telescope 20. The telescope 20 may be controlled by a remote control 24 that is in communication with the telescope 20 via a control cord 26 or other communication means. It can be appreciated that the motor controls of the telescope 20 may be controlled directly by the computer system 100 via similar communication means.

As shown in FIG. 4 of the drawings, a mounting bracket 22 is attached to the telescope 20 for attaching the telescope 20 to a roof, exterior wall or deck of a building structure. The mounting bracket 22 may also be utilized to attach the telescope 20 to a post or similar structure wherein a threaded engaging member is utilized to tighten the mounting bracket 22 about the post as best shown in FIG. 4 of the drawings.

A transparent lens cover 29 is preferably positionable about the distal end of the telescope 20 for protecting the distal lens from weather and other damaging effects as shown in FIGS. 1,3 and 4 of the drawings. The lens cover 29 is preferably constructed from a plastic material and has a domed shaped for deflecting debris and water. The lens cover 29 is formed for snugly fitting about the distal portion of the telescope 20 as shown in FIGS. 1,3 and 4 of the drawings.

As shown in FIGS. 1 through 4 of the drawings, a digital camera 30 is provided for digitally recording images viewable within the eyepiece 28 of the telescope 20. The camera 30 may be comprised of any well-known digital camera 30 structure that are commonly utilized within the personal computer industry and are deemed readily apparent to one skilled in the art. A data cord 32 or other communication means is utilized to transfer the data images to the computer system 100 as shown in FIG. 1 of the drawings.

A tubular coupler member 34 is provided that is attached to the camera 30 and extends from thereof to surround the eyepiece 28 as shown in FIGS. 1 through 4 of the drawings. The tubular coupler prevents debris from entering the eyepiece 28 and ensures that only the image viewable within the eyepiece 28 is recorded by the camera 30. The coupler member 34 is preferably constructed of a opaque material.

In use, the user mounts the telescope 20 in a desired location such as upon the roof of their home using the mounting bracket 22. The user then positions the lens cover 29 about the distal portion of the telescope 20 for protecting the outer lens from damage. The user then positions the coupler member 34 with the camera 30 about the eyepiece 28 of the telescope 20. The camera 30 digitally records the celestial images displayed through the eyepiece 28 and then transmits the celestial images digitally to the computer system 100. The computer system 100 receives the celestial images from the camera 30 and then displays the celestial images from the upon display screen 104 as shown in FIG. 1 of the drawings. The user may utilize the remote control 24 or the computer system 100 to control the operation and position of the telescope 20 from the comfort of their home.

As to a further discussion of the manner of usage and operation of the present invention, the same should be apparent from the above description. Accordingly, no further discussion relating to the manner of usage and operation will be provided.

The foregoing descriptions of embodiments of the invention have been presented for purposes of illustration and description only. They are not intended to be exhaustive or to limit the invention to the forms disclosed. Accordingly, many modifications and variations will be apparent to practitioners skilled in the art. Additionally, the above disclosure is not intended to limit the invention. The scope of the invention is defined by the appended claims.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A telescope viewing system, comprising:
a computer system having a display screen;
a telescope having a distal lens and an eyepiece;
a camera in communication with said computer system; and
a coupler member attached to said camera and positionable about said eyepiece of said telescope for allowing said camera to record celestial images displayed within said eyepiece.

2. The telescope viewing system of claim 1, wherein said camera is comprised of a digital system.

3. The telescope viewing system of claim 2, wherein said telescope includes a motor control system.

4. The telescope viewing system of claim 3, wherein said motor control system of said telescope is controlled by said computer system.

5. The telescope viewing system of claim 1, wherein said coupler member is tubular in shape and constructed of an opaque material.

6. The telescope viewing system of claim 5, wherein said camera is comprised of a digital system.

7. The telescope viewing system of claim 6, wherein said telescope includes a motor control system.

8. The telescope viewing system of claim 7, wherein said motor control system of said telescope is controlled by said computer system.

9. The telescope viewing system of claim 8, wherein said coupler member has a first end and a second end, wherein said first end is concentrically attached about a first lens of said camera and wherein said second end is concentrically attached about said eyepiece of said telescope.

10. The telescope viewing system of claim 9, including a remote control in communication with said telescope.

11. A telescope viewing system, comprising:
a computer system having a display screen;
a telescope having a distal lens and an eyepiece;
a mounting bracket for mounting said telescope to a stationary object;
a camera in communication with said computer system; and
a coupler member attached to said camera and positionable about said eyepiece of said telescope for allowing said camera to record celestial images displayed within said eyepiece.

12. The telescope viewing system of claim 11, wherein said camera is comprised of a digital system.

13. The telescope viewing system of claim 12, wherein said telescope includes a motor control system.

14. The telescope viewing system of claim 13, wherein said motor control system of said telescope is controlled by said computer system.

15. The telescope viewing system of claim 1 1, wherein said coupler member is tubular in shape and constructed of an opaque material.

16. The telescope viewing system of claim 15, wherein said camera is comprised of a digital system.

17. The telescope viewing system of claim 16, wherein said telescope includes a motor control system.

18. The telescope viewing system of claim 17, wherein said motor control system of said telescope is controlled by said computer system.

19. The telescope viewing system of claim 18, wherein said coupler member has a first end and a second end, wherein said first end is concentrically attached about a first lens of said camera and wherein said second end is concentrically attached about said eyepiece of said telescope.

20. The telescope viewing system of claim 19, including a lens cover comprised of a transparent domed structure, wherein said lens cover is formed for snugly fitting about a distal portion of said telescope.
